(19) United States
(12) Patent Application Publication
(10) Pub. No.: US 2015/0016382 A1
(43) Pub. Date: Jan. 15, 2015

(54) METHOD AND APPARATUS FOR PERFORMING TRACKING AREA UPDATE (TAU) BY USER EQUIPMENT (UE) IN C-RAN SYSTEM

(71) Applicant: LG ELECTRONICS INC., Seoul (KR)

(72) Inventors: Youngsoo Yuk, Anyang-si (KR); Sunam Kim, Anyang-si (KR); Jaehoon Chung, Anyang-si (KR)

(73) Assignee: LG ELECTRONICS INC., Seoul (KR)

(21) Appl. No.: 14/380,658

(22) PCT Filed: Feb. 25, 2013
(86) PCT No.: PCT/KR2013/001480

§ 371 Date: Aug. 22, 2014

Related U.S. Application Data
(60) Provisional application No. 61/602,602, filed on Feb. 24, 2012.

(51) Int. Cl. H04W 76/02; H04W 24/10; H04W 74/08

(52) U.S. Cl. CPC H04W 76/021; H04W 74/0833; H04W 24/10
USPC 370/329; 370/328

(57) ABSTRACT

A method and apparatus for performing tracking area update (TAU) by a user equipment (UE) in a C-RAN system is disclosed. The method for performing a tracking area update (TAU) by a user equipment (UB) in a Cloud Radio Access Network (C-RAN) includes: transmitting a message, that includes a tracking area update (TAU) indicator indicating a tracking area update (TAU), to a serving Remote Radio Head (S-RRH), wherein the tracking area update (TAU) is performed in units of a Remote Radio Head (RRH) cluster.

### TECHNICAL FIELD

The present invention relates to wireless communication, and more particularly to a method and apparatus for performing tracking area update (TAU) by a user equipment (UE) in a Cloud Radio Access Network (C-RAN) system.

### BACKGROUND ART

The 30-years history of mobile communication commercialization on the basis of AMPS (the first-generation analog mobile communication systems) has caused a rapid change in society, such that mobile communication technologies have rapidly come into widespread use and been commercialized throughout the world. Specifically, mobile communication networks have generated a variety of changes throughout modern society in recent times, and have also rapidly developed.

Expansion of third-generation communication system has been considerably delayed due to irregular development of mobile communication and mobile computing, and fourth-generation communication systems have been rapidly developed in response to the computing environment rapidly changing from personal computers (PCs) such as desktop computers and laptops to personal information devices such as smartphones and tablets. Particularly, the recent development of cloud computing environments requires an organic combination of higher-level communication/computing technologies, such that the above-mentioned tendency will be accelerated.

In recent times, as LTE-Advanced and WiMAX-Advanced are approved as fourth-generation IMT-Advanced standards by the ITU, many developers and companies are conducting intensive research into fifth-generation mobile communication systems. For example, ITU-R WP5D taking charge of IMT serving as one of the international mobile communication standards has held a local Workshop entitled “IMT for the Next Decade” in 2011, such that the ITU-R WP5D are actively carrying out various activities arousing user interest in fifth-generation communication. Besides, WWRF has investigated requirements and versions of the NG-Wireless system and a first report has been published by the WWRF.

Since the communication service environment has rapidly changed over the last decade, it is very difficult for users to predict how much the communication service environment will change in the next decade. Recently, current communication standard organizations such as ITU-R and WWRF have considered the following change factors for 5G communication up to the year 2020.
Development of Multimedia Service based on high-quality video service.
Provision of differentiated User eXperience (UX) through personalization service: Provision of services suited to personal interest, situation, and equipment.
Communication environment change from device-oriented communication environment to user-oriented communication environment: A user owns a plurality of communication devices, provision of user-oriented services is requested. For example, content charging, provision of seamless mobility between heterogeneous devices and security service between heterogeneous devices may be the user-based services.
Extension of M2M service: Increasing traffic through increase in the number of M2M devices and provision of new M2M-based services are requested.
Low Variation of Mobile Cloud Computing environment: all computing environments are coupled to the network, such that mobile cloud computing is provided through provision of lower-latency and higher-performance communication environments. The following important requirements of 5G communication systems have been discussed according to the changing service environment.

1. Increase of Bandwidth/Transfer Rate

According to various research reports, it is expected that the number of mobile devices and the amount of traffic will rapidly increase over the next decade. In case of mobile devices, whereas an increase in population is not large, it is expected that low-end UEs will be replaced with Internet UEs such as smartphones or tablets and the number of connected UEs such as M2M will rapidly increase.

According to a report from Cisco, the amount of overall mobile traffic has increased by about six fold from 2008 to 2010, and will increase 26 fold by 2015 year such that monthly mobile traffic will be 6.3 EB per month. UMTS has predicted that the overall amount of mobile traffic will change from an annual of 3.8 EB in 2010 to 127 EB (corresponding to about 33 times the annual of 3.8 EB) by 2020 by referring to IDATE documents. For some years from 2010 to 2020, it is expected that the number of mobile UEs will be increased about two fold such that the number of mobile UEs will be increased from 5 billion to about 10 billion.

It can be recognized that a first object of the 5G mobile communication system is to increase a transfer rate on the basis of the above-mentioned tendency. Although various methods can be used to increase transfer rate, a first method is to find/use an additional bandwidth that is not presently being used.

Although current mobile communication systems mainly operate at 3 GHz or less, many developers and companies are conducting intensive research into higher bands due to bandwidth limitations. Specifically, various methods for guaranteeing system performance in response to frequency characteristics changed within a high frequency band of 2˜6 GHz band have been intensively researched by many developers and companies.

2. Provision of Uniform Service Quality

4G communication implements a maximum transfer rate of 1 Gbps such that it has been greatly improved in terms of a transfer rate. However, the 4G communication system has serious unbalance in service quality between a cell edge region and normal cell regions because a difference between spectrum efficiency of the cell edge region and average spectrum efficiency of a cell is 30 times or more. Due to the motto “Provision of Desired Service from anywhere at any time” of the 5G communication system, improvement of an unbalanced service quality is of importance to the 5G communication system.

In association with the above-mentioned description, although many developers and companies are conducting intensive research into performance improvement in the cell edge region through WiFi offloading, addition of an auxiliary cell such as Femto BS, eICIC (Enhanced Inter-cell Interference Coordination) and CoMP (Coordinated Multi-Point) technologies for use in the 4G system, there is a need to provide a higher-level uniform service.

3. User-Oriented Organic Interoperation

Although the 4G system has implemented interoperation between devices on the basis of user handling or predetermined policy, the next-generation communication system requires diversification of UEs, organic interoperation of several devices, and various technologies for providing the same service level in various communication environments. There are needed various technologies in which communication technologies such as cellular or WLAN are organically interoperable without using complicated processes and user intervention is minimized through seamless services.

In order to satisfy the above-mentioned requirements, requirements for communication network fields are being intensively researched. However, a method for enabling a UE to efficiently perform Tracking Area Update (TAU) in the C-RAN system has not yet been researched and discussed.

### DISCLOSURE OF INVENTION

### Technical Problem

Accordingly, the present invention is directed to a method and apparatus for performing Tracking Area Update (TAU) by a user equipment (UE) in a Cloud Radio Access Network (C-RAN) system that substantially obviates one or more problems due to limitations and disadvantages of the related art.

An other object of the present invention is to provide a method for performing Tracking Area Update (TAU) by a user equipment (UE) in a Cloud Radio Access Network (C-RAN) system.

Another object of the present invention is to provide a user equipment (UE) for performing tracking area update (TAU) in a C-RAN system.

It is to be understood that technical objects to be achieved by the present invention are not limited to the aforementioned technical objects and other technical objects which are not mentioned herein will be apparent from the following description to one of ordinary skill in the art to which the present invention pertains.

### Solution to Problem

The object of the present invention can be achieved by providing a method for performing a tracking area update (TAU) by a user equipment (UE) in a Cloud Radio Access Network (C-RAN), the method including: transmitting a message, including a tracking area update (TAU) indicator indicating a tracking area update (TAU), to a serving Remote Radio Head (S-RRH), wherein the tracking area update (TAU) is performed in units of a Remote Radio Head (RRH) cluster. The TAU indicator may indicate whether the TAU is a TAU according to a change of an identifier (ID) of a serving base station or a core network, or is a TAU according to a change of the RRH cluster. The TAU indicator may be indicated by a random access sequence specifically allocated to the user equipment (UE) in a process for performing random access to the serving RRH. The TAU indicator may be indicated by transmission of a MAC message after completion of the random access to the serving RRH. The TAU may be performed in units of an RRH cluster and a tracking area (TA) is allocated according to UE mobility.

The method may further include: if the TAU indicator indicates a TAU caused by the changed of an identifier (ID) of the serving base station or the core network, requesting a TAU from the core network.

The method may further include: if the TAU indicator indicates a TAU caused by the change of the RRH cluster, receiving a TAU confirmation message from the serving RRH, wherein the UE does not request a TAU from the core network upon receiving the TAU confirmation message.

In another aspect of the present invention, a user equipment (UE) for performing a tracking area update (TAU) in a Cloud Radio Access Network (C-RAN) includes: a transmitter; and a processor, wherein the processor is configured to control the transmitter transmits a message including a tracking area update (TAU) indicator indicating a tracking area update (TAU), to a serving Remote Radio Head (S-RRH), and wherein the processor is configured to control that the tracking area update (TAU) is performed in units of a Remote Radio Head (RRH) cluster.

### Advantageous Effects of Invention

As is apparent from the above description, a UE can efficiently perform tracking area update (TAU) in a C-RAN system.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF DRAWINGS

The accompanying drawings, which are included to provide a further understanding of the invention, illustrate embodiments of the invention and together with the description serve to explain the principle of the invention.

FIG. 1 is a block diagram illustrating a base station (BS) and a user equipment (UE) for use in a wireless communication system.

FIG. 2 is a conceptual diagram illustrating modification of BS/RAN structures through an RRH concept and RRH.

FIG. 3 is a conceptual diagram illustrating a cloud network based on C-RAN.

FIG. 4 is a conceptual diagram illustrating a user-oriented cell.

FIG. 5 is a conceptual diagram illustrating an RRH and virtual BS (VBS) shared scenario in C-RAN.

FIG. 6 is a conceptual diagram illustrating a model of multiple control layers.

FIG. 7 is a conceptual diagram illustrating a next-generation network supporting situation-cognition based intelligence interoperation.

FIG. 8 is a flowchart illustrating a method for performing RAN-based TAU according to embodiments of the present invention.

### BEST MODE FOR CARRYING OUT THE INVENTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details. For example, the following description will be given centering upon a mobile communication system serving as a 3GPP LTE system, but the present invention is not limited thereto and the remaining parts of the present invention other than unique characteristics of the 3GPP LTE system are applicable to other mobile communication systems.

In some cases, in order to prevent ambiguity of the concepts of the present invention, conventional devices or apparatuses well known to those skilled in the art will be omitted and be denoted in the form of a block diagram on the basis of important functions of the present invention. Wherever possible, the same reference numbers will be used throughout the drawings to refer to the same or like parts.

In the following description, a terminal may refer to a mobile or fixed user equipment (UE), for example, a user equipment (UE), a mobile station (MS) and the like. Also, the base station (BS) may refer to an arbitrary node of a network end which communicates with the above terminal, and may include an eNode B (eNB), a Node B (Node-B), an access point (AP) and the like. Although the embodiments of the present invention are disclosed on the basis of IEEE 802.16 for convenience of description, contents of the present invention can also be applied to other communication systems.

In a mobile communication system, the UE may receive information from the base station (BS) via a downlink, and may transmit information via an uplink. The information that is transmitted and received to and from the UE includes data and a variety of control information. A variety of physical channels are used according to categories of transmission (Tx) and reception (Rx) information of the UE.

The following embodiments of the present invention can be applied to a variety of wireless access technologies, for example, CDMA (Code Division Multiple Access), FDMA (Frequency Division Multiple Access), TDMA (Time Division Multiple Access), OFDMA (Orthogonal Frequency Division Multiple Access), SC-FDMA (Single Carrier Frequency Division Multiple Access), and the like. CDMA may be embodied through wireless (or radio) technology such as UTRA (Universal Terrestrial Radio Access) or CDMA2000. TDMA may be embodied through wireless (or radio) technology such as GSM (Global System for Mobile communication)/GPRS (General Packet Radio Service)/EDGE (Enhanced Data Rates for GSM Evolution). OFDMA may be embodied through wireless (or radio) technology such as Institute of Electrical and Electronics Engineers (IEEE) 802.11 (Wi-Fi), IEEE 802.16 (WiMAX), IEEE 802-20, and E-UTRA (Evolved UTRA). UTRA is a part of UMTS (Universal Mobile Telecommunications System). 3GPP (3rd Generation Partnership Project) LTE (long term evolution) is a part of E-UMTS (Evolved UMTS), which uses E-UTRA. 3GPP LTE employs OFDMA in downlink and employs SC-FDMA in uplink. LTE-Advanced (LTE-A) is an evolved version of 3GPP LTE.

It should be noted that specific terms disclosed in the present invention are proposed for convenience of description and better understanding of the present invention, and the use of these specific terms may be changed to other formats within the technical scope or spirit of the present invention.

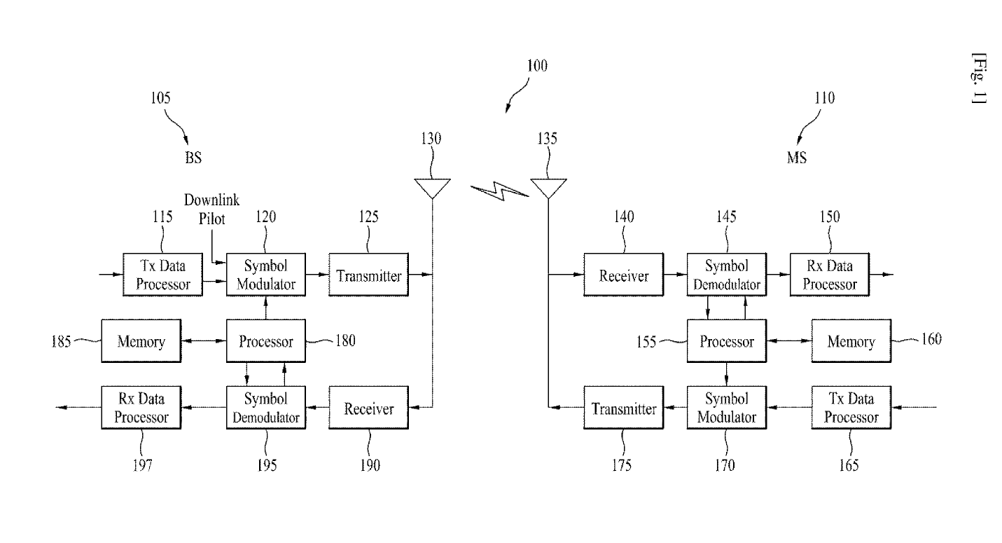

FIG. 1 is a block diagram illustrating a base station (BS) 105 and a user equipment (UE) 110 for use in a wireless communication system 100 according to the present invention.

Although FIG. 1 shows one UE 105 and one UE 110 (including a D2D UE) for brief description of the wireless communication system 100, it should be noted that the wireless communication system 100 may further include one or more BSs and/or one or more UEs.

Referring to FIG. 1, the BS 105 may include a transmission (Tx) data processor 115, a symbol modulator 120, a transmitter 125, a transmission/reception antenna 130, a processor 180, a memory 185, a receiver 190, a symbol demodulator 195, and a reception (Rx) data processor 197. The UE 110 may include a Tx data processor 165, a symbol modulator 170, a transmitter 175, a transmission/reception antenna 135, a processor 155, a memory 160, a receiver 140, a symbol demodulator 155, and an Rx data processor 150. In FIG. 1, although one antenna 130 is used for the BS 105 and one antenna 135 is used for the UE 110, each of the BS 105 and the UE 110 may also include a plurality of antennas as necessary. Therefore, the BS 105 and the UE 110 according to the present invention support a Multiple Input Multiple Output (MIMO) system. The BS 105 according to the present invention can support both a Single User-MIMO (SU-MIMO) scheme and a Multi User-MIMO (MU-MIMO) scheme.

In downlink, the Tx data processor 115 receives traffic data, formats the received traffic data, codes the formatted traffic data, interleaves the coded traffic data, and modulates the interleaved data (or performs symbol mapping upon the interleaved data), such that it provides modulation symbols (i.e., data symbols). The symbol modulator 120 receives and processes the data symbols and pilot symbols, such that it provides a stream of symbols.

The symbol modulator 120 multiplexes data and pilot symbols, and transmits the multiplexed data and pilot symbols to the transmitter 125. In this case, each transmission (Tx) symbol may be a data symbol, a pilot symbol, or a value of a zero signal (null signal). In each symbol period, pilot symbols may be successively transmitted during each symbol period. The pilot symbols may be an FDM symbol, an OFDM symbol, a Time Division Multiplexing (TDM) symbol, or a Code Division Multiplexing (CDM) symbol.

The transmitter 125 receives a stream of symbols, converts the received symbols into one or more analog signals, and additionally adjusts the one or more analog signals (e.g., amplification, filtering, and frequency upconversion of the analog signals), such that it generates a downlink signal appropriate for data transmission through an RF channel. Subsequently, the downlink signal is transmitted to the UE through the antenna 130.

Configuration of the UE 110 will hereinafter be described in detail. The antenna 135 of the UE 110 receives a DL signal from the BS 105, and transmits the DL signal to the receiver 140. The receiver 140 performs adjustment (e.g., filtering, amplification, and frequency downconversion) of the received DL signal, and digitizes the adjusted signal to obtain samples. The symbol demodulator 145 demodulates the received pilot symbols, and provides the demodulated result to the processor 155 to perform channel estimation.

The symbol demodulator 145 receives a frequency response estimation value for downlink from the processor 155, demodulates the received data symbols, obtains data symbol estimation values (indicating estimation values of the transmitted data symbols), and provides the data symbol estimation values to the Rx data processor 150. The Rx data processor 150 performs demodulation (i.e., symbol-demapping) of data symbol estimation values, deinterleaves the demodulated result, decodes the deinterleaved result, and recovers the transmitted traffic data.

The processing of the symbol demodulator 145 and the Rx data processor 150 is complementary to that of the symbol modulator 120 and the Tx data processor 115 in the BS 205.

The Tx data processor 165 of the UE 110 processes traffic data in uplink, and provides data symbols. The symbol modulator 170 receives and multiplexes data symbols, and modulates the multiplexed data symbols, such that it can provide a stream of symbols to the transmitter 175. The transmitter 175 receives and processes the stream of symbols to generate an uplink (UL) signal, and the UL signal is transmitted to the BS 105 through the antenna 135.

The BS 105 receives the UL signal from the UE 110 through the antenna 130. The receiver processes the received UL signal to obtain samples. Subsequently, the symbol demodulator 195 processes the symbols, and provides pilot symbols and data symbol estimation values received via uplink. The Rx data processor 197 processes the data symbol estimation value, and recovers traffic data received from the UE 110.

A processor 155 or 180 of the UE 110 or the BS 105 commands or indicates operations of the UE 110 or the BS 105. For example, the processor 155 or 180 of the UE 110 or the BS 105 controls, adjusts, and manages operations of the UE 210 or the BS 105. Each processor 155 or 180 may be connected to a memory unit 160 or 185 for storing program code and data. The memory 160 or 185 is connected to the processor 155 or 180, such that it can store the operating system, applications, and general files.

While the UE processor 155 enables the UE 110 to receive signals and can process other signals and data, and the BS processor 180 enables the BS 105 to transmit signals and can process other signals and data, the processors 155 and 180 will not be specially mentioned in the following description. Although the processors 155 and 180 are not specially mentioned in the following description, it should be noted that the processors 155 and 180 can process not only data transmission/reception functions but also other operations such as data processing and control.

The processor 155 or 180 may also be referred to as a controller, a microcontroller), a microprocessor, a microcomputer, etc. In the meantime, the processor 155 or 180 may be implemented by various means, for example, hardware, firmware, software, or a combination thereof. In a hardware configuration, methods according to the embodiments of the present invention may be implemented by the processor 155 or 180, for example, one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, methods according to the embodiments of the present invention may be implemented in the form of modules, procedures, functions, etc. which perform the above-described functions or operations. Firmware or software implemented in the present invention may be contained in the processor 155 or 180 or the memory unit 160 or 185, such that it can be driven by the processor 155 or 180.

Radio interface protocol layers among the UE 110, the BS 105, and a wireless communication system (i.e., network) can be classified into a first layer (L1 layer), a second layer (L2 layer) and a third layer (L3 layer) on the basis of the lower three layers of the Open System Interconnection (OSI) reference model widely known in communication systems. A physical layer belonging to the first layer (L1) provides an information transfer service through a physical channel. A Radio Resource Control (RRC) layer belonging to the third layer (L3) controls radio resources between the UE and the network. The UE 110 and the BS 105 may exchange RRC messages with each other through the wireless communication network and the RRC layer.

While the UE processor 155 enables the UE 110 to receive signals and can process other signals and data, and the BS processor 180 enables the BS 105 to transmit signals and can process other signals and data, the processors 155 and 180 will not be specially mentioned in the following description. Although the processors 155 and 180 are not specially mentioned in the following description, it should be noted that the processors 155 and 180 can process not only data transmission/reception functions but also other operations such as data processing and control.

5G communication network technology is largely classified into a radio access network field and a core network field. Generally, two technical fields are present in the radio access network field. First, a centralized access network may be used through introduction of a network cloud. Three core technologies for implementing the network cloud are Remote Radio Head (RRH)/Coordinated Multi-Point (CoMP) technology, software modem technology, and cloud computing technology.

The most important core technology for implementing the network cloud in the radio access network field is the introduction of RRH. Although RRH is very important in terms of radio transmission, the RRH may greatly change a radio access network structure.

FIG. 2 is a conceptual diagram illustrating modification of BS/RAN structures through RRH concept and RRH.

Although RRH has been developed as one of optical repeaters, RRH has recently been used as a core element to implement a centralized base station. The most important core technology for implementing the network cloud in the radio access network field is the introduction of RRH. RRH is very important in terms of radio transmission, and may greatly change the radio access network structure. With the introduction of RRH, a conventional base station is no longer physically distributed due to physical distribution of Radio Frequency Units (RFUs) and Baseband Units (BBUs). Recently, a cloud access network is interoperable with several hundreds of RRHs through only one device so as to implement network operation/management, resulting in formation of a cell different from a typical cell.

Although communication systems to the 4G communication system have defined all radio access operations on the basis of a cell, a new cell concept needs to be established through the above structural change. Presently, 3GPP has intensively proposed various scenarios on the condition that RRH and a macro BS are present through Release 11 CoMP (Coordinated Multi-Point) Work Item. In recent times, various research into enabling several cells to share one RRH as in a Shared Antenna System (SAS) have also been proposed. In addition, a method for dynamically changing a cell region by adjusting an RRH cluster according to a situation has also been recently proposed. Due to these situations, user interest in the Cloud Radio Access Network (C-RAN) project is rapidly increasing.

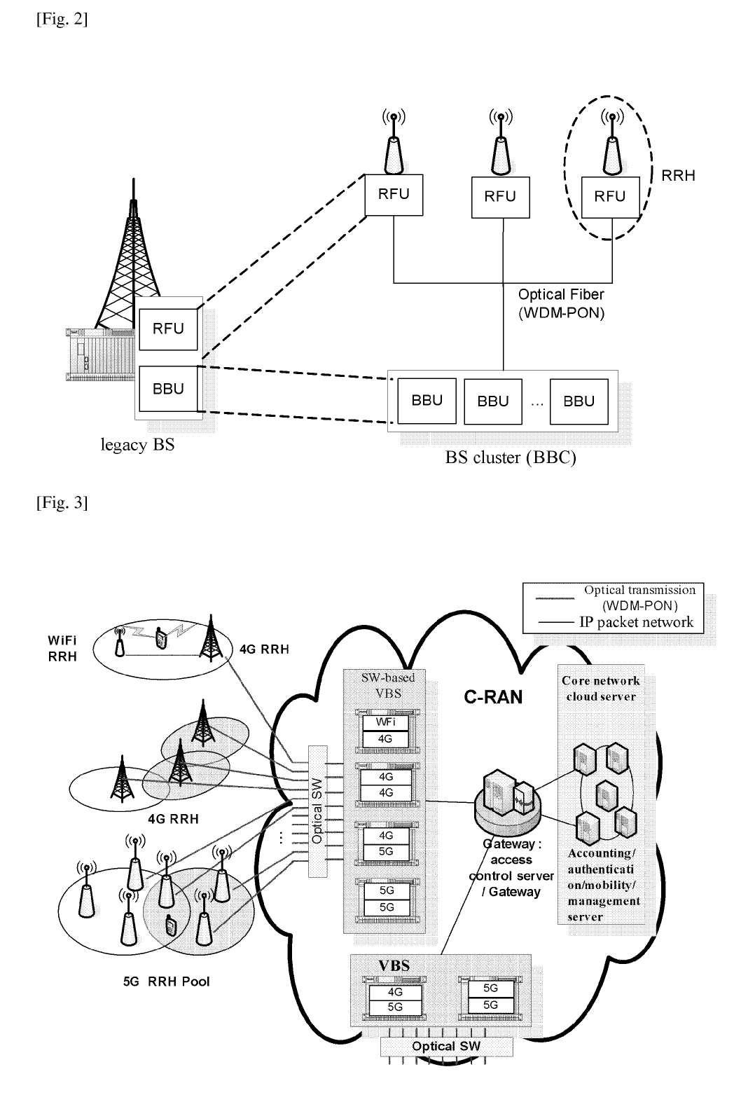

FIG. 3 is a conceptual diagram illustrating a cloud network based on C-RAN.

FIG. 3 is a conceptual diagram of a C-RAN. The C-RAN may include a plurality of RRHs, a software-based virtual base station (VBS), an access control server for con-trolling RRHs and VBSs, and a core network cloud server (including a resource management server, an accounting/authentication server, etc.). As described above, as elements of the core network are gradually changed to the open IP network, C-RAN elements are organically interoperable with the core network elements.

Referring to FIG. 3, several RRGs are connected to a virtual base station (VBS) through an optical access device. The VBS is implemented by software, and may be implemented by various radio access technologies such as Long Term Evolution (LTE), HSPA, WiMAX/WiFi, etc., and one or more RRHs are grouped and controlled by a single VBS. While the cell region is fixed in the related art, C-RAN dynamically changes RRH clusters so that cells can be dynamically allocated. Such dynamic allocation may also be adjusted according to distribution of users present in the region. Therefore, there is a need to consider a method for removing the cell concept and constructing a cell per user.

As can be seen from FIG. 3, several RRHs are connected to the VBS through an optical access device. The VBS may be implemented by software, and may also be implemented by various radio access technologies such as LTE, HSPA, WiMAX/WiFi, etc. One or more RRHs are grouped and controlled by a single VBS. While the cell region is fixed in the related art, RRH clusters are dynamically changed in the C-RAN system so that cells can be dynamically allocated.

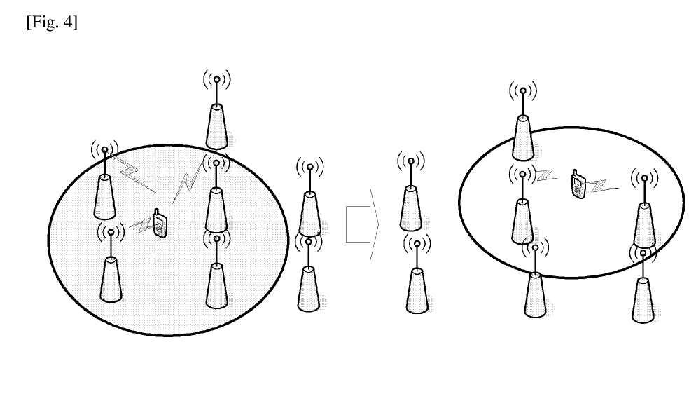

FIG. 4 is a conceptual diagram illustrating a user-oriented cell.

In C-RAN, RRH clusters are dynamically changed so that cells are dynamically allocated. Such dynamic allocation may also be adjusted according to distribution of users present in the region. Some developers and companies have conducted intensive research into a method for removing the cell concept and constructing a per-user cell on the basis of a current user.

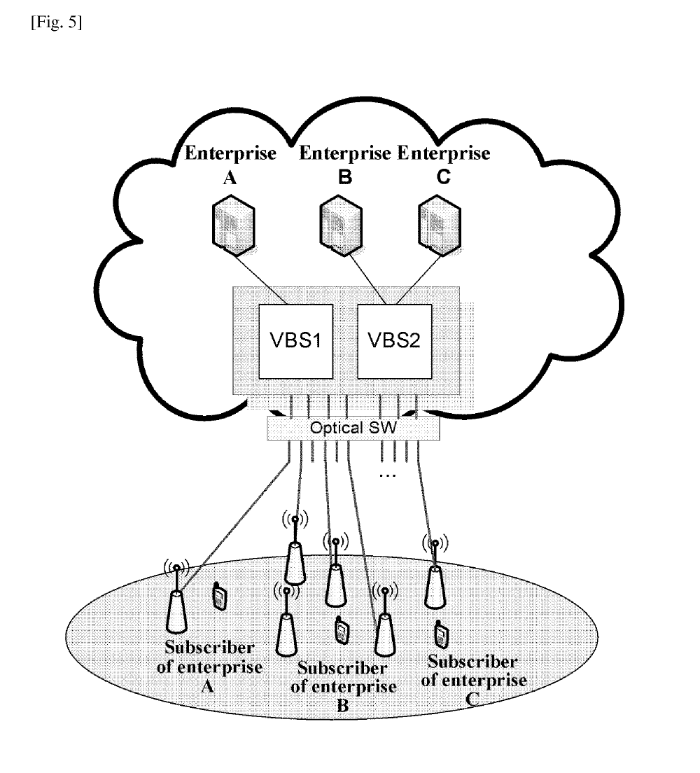

FIG. 5 is a conceptual diagram illustrating an RRH and VBS shared scenario in C-RAN.

A virtual structure such as a C-RAN has proposed a new possibility in consideration of network opening and network sharing characteristics. Individual countries have executed various policies [e.g., MVNO, BS (Base Station)/AP (Access Point)] to introduce competitive elements to a communication market. For example, MVNO, BS (Base Station)/AP (Access Point), etc. If the VBS is introduced to the market, it is possible to use various service scenarios, for example, a virtual enterprise may construct a VBS under the condition that an interface with an RRH is maintained, and the same radio resources may be shared by a plurality of VBSs.

In FIG. 5, enterprises A, B and C may share the same RRH pool so as to provide services. Especially, the enterprise B and the enterprise C may provide different services using the same VBS. The VBS enterprise may charge a usage fee to each of the enterprises B and C according to the amount of radio resources used. Each enterprise applies a unique resource allocation policy to predetermined radio resources so as to support a subscriber.

Services for selling frequency resources in real time have recently been activated in the United States of America, and a new frequency-associated business capable of leasing some frequency resources may also be possible in the VBS environment.

The second important flow of the radio access network field is to strengthen a distributed layer. Although the centralized and central processing function of the radio access network has been strengthened through C-RAN, there is a limit to the capabilities of the VBS and access server of the C-RAN. Specifically, assuming that a base station (BS) such as a femto BS is connected through a private IP network, it is very difficult to manage the BS in real time. In addition, it is very difficult for the network to control all operations of Device-to-Device (D2D) communication. As a result, while a common access network based on C-RAN evolves in the form of central control processing, localized communication such as femto BS and D2D communication may have a distributed control structure.

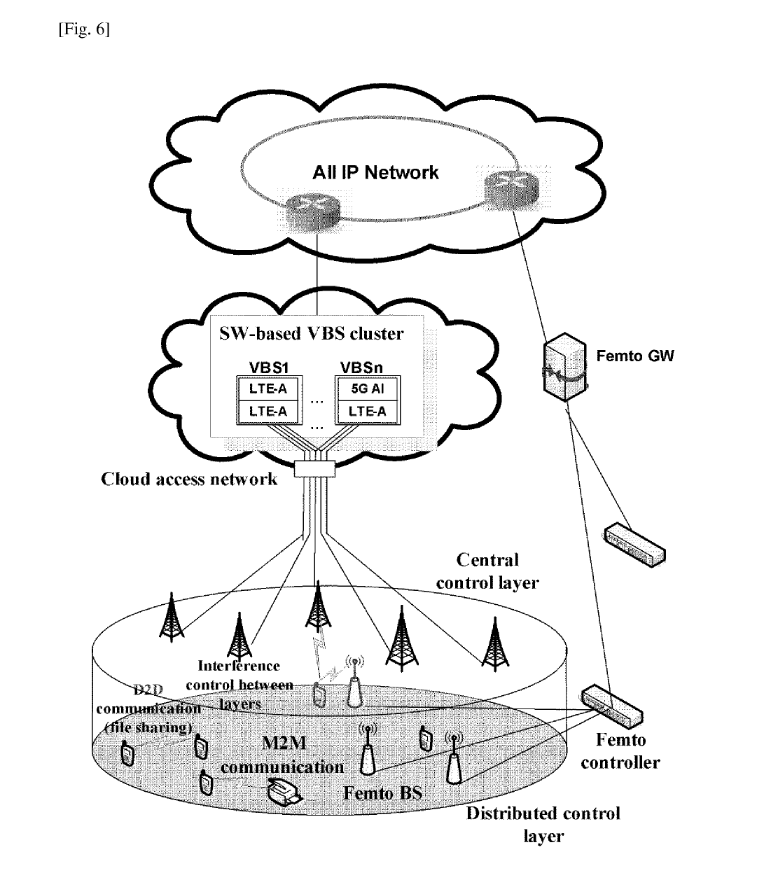

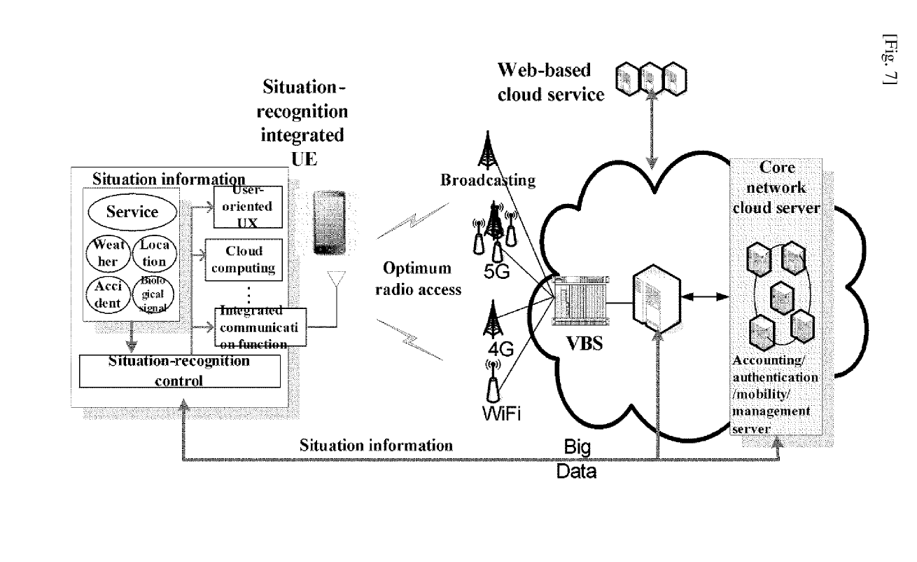

FIG. 6 is a conceptual diagram illustrating a model of multiple control layers.

Referring to FIG. 6, a model of the multiple control layers (hereinafter referred to as a multi-control layer model) includes a central control layer controlled through a cloud access network and a distributed control layer. The distributed control layer is controlled by each communication entity whereas it is partially controlled by the central control layer. Studies into interference control for coexistence between layers are of importance to the multi-control layer model.

In the core network aspect, it is expected that the core network will evolve into an All IP-based Open Network in view of 4G system continuity. In recent times, various services have a tendency to be changed from network enterprise based services such as IMS to Web/application layer based services. The above-mentioned fact can be confirmed through a comparison between the enterprise based Rich Communication Suite (RCS) and the service enterprise based Over The Top (OTT) service. Although it is difficult for the user to make a hasty conclusion of the confirmation result, SMS-, MMS-, and IMS-based RCS services of communication companies will be replaced with OTT services such as Kakao Talk and Skype.

Specifically, the aforementioned tendency will be accelerated through activation of the next-generation Web standards such as HLML5 and mobile cloud services. In response to change of service fields, the core network function will focus on provision of IP transport to a radio network, and it is expected that the core network will be developed from the legacy voice-service-based hierarchical network to a more horizontal IP network. As a result, many conventional network elements are simplified in structure, and network elements are gradually changed from the large-sized server-dependent structure to a structure implemented through a plurality of core network cloud servers, such that the above-mentioned network development can be achieved through lower CAPEX/OPEX.

The latent principal issue of the core network other than service provision is provision of IP flow mobility. Heterogeneous network support technology such as Multi-Access PDN connectivity (MAPCON) or IP Flow Mobility (IFOM) has been standardized in 3GPP SA2. Specifically, offloading through interaction with a WLAN is of importance to 3GPP SA2. In contrast, with the introduction of C-RAN, an interaction structure between heterogeneous networks is simplified so that it is expected that IP-based mobility control will also be greatly simplified. Assuming that the related art has proposed services through two different PDNs, the above-mentioned services can be implemented by only one method through interaction between the C-RAN access control server and the core-network integrated mobility control server, irrespective of the radio access scheme employed. In addition, an Access Node Discovery and Selection Function (ANDSF) being introduced for the offloading policy may be easily contained in the core network (CN) mobility control server region and then simplified.

In recent times, as information technology devices become highly intelligent, management elements that have been confined to UE radio characteristics, traffic types, accounting, authentication, etc. will evolve in more various ways. A smartphone of the user collects basic information, personal location information, use and movement pattern, user interest, biomedical or vital information, etc., and the network will provide user-oriented services using the above-mentioned information. For this purpose, it is expected that a function for collecting/processing large volumes of data will be added to the core network and then strengthened. While the legacy core network provides necessary services on the basis of the enterprise policy, a method for collecting, analyzing, and processing large volumes of data so as to provide the user-oriented service will be intensively discussed and studied in the next-generation communication network.

Specifically, interaction between heterogeneous networks is facilitated, such that providing optimum radio access suitable for a current situation through analysis of the corresponding big data is of importance to the network enterprise and users.

The importance of research into associated technical fields will gradually increase.

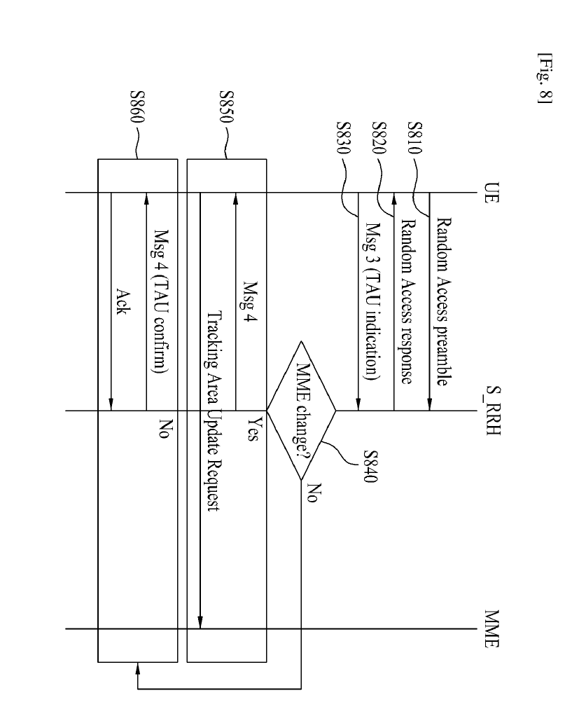

FIG. 7 is a conceptual diagram illustrating a next-generation network supporting situation-cognition based intelligence interoperation.

Referring to FIG. 7, various information collected by a UE is transferred to the access network server and the core network server, such that an optimum access environment of the UE can be controlled on the basis of the collected information.

The above-mentioned description has disclosed the network evolution for the next-generation communication system in view of the radio access network and the core network. The radio access network evolves into the cloud network such that extensibility and network flexibility will be improved. In addition, as the control region is gradually extended due to centralization, a large number of functions associated with legacy core network communication will be connected to the access network. In contrast, as the core network is gradually developed in consideration of network intelligence, it will be possible to provide an intelligent access control function and an interaction control function based on various situation information collected by a user, an access network and other environmental elements. The development direction of 5G communication has just started to be laid out. It is expected that 5G communication technology will be developed to a new wireless communication technology accompanied with appearance of IT technology and bio- or nano-technology.

Idle Mode Mobility Enhancement

A user equipment (UE) operating in an idle mode of LTE or WiMAX has the following three principal operations.

1. Idle Mode Termination by UE (Network Entry/Reentry)

2. Reception of Paging Message

3. Location Registration (Tracking Area Update)

The embodiment of the present invention proposes a method for performance improvement in a Cloud RAN (C-RAN) environment.

1. Idle Mode Termination by UE

In this case, the UE operates in the same manner as in the legacy LTE or WiMAX system on the basis of random access.

2. Reception of Paging Message

Option 1: The same paging message can be transmitted in units of a tracking area in the same manner as in the related art. In this case, numerous nodes must participate in paging message transmission, such that a large amount of resources are consumed to transmit only one paging message.

Option 2: Paging Message Transmission in units of RRH Cluster

In a C-RAN environment, connected RRHs are RRHs which actually participate in data transmission/reception and can be allocated by a base station (BS). The set of association RRHs is an aggregate of RRHs configured to enable the UE to periodically perform monitoring according to situation, and corresponds to candidate RRHs serving as connected RRHs. The present invention considerably reduces the problems of Option 1 and proposes a method for transmitting a paging message in units of an RRH cluster to reduce the number of simultaneous transmission nodes. In this case, the RRH cluster may be defined as an associated RRH set of RRHs, and may also be composed of a plurality of associated RRH sets. The amount of resources used may be changed according to the size of this set.

3. Tracking Area Update (TAU)

TAU serves two usages. According to a first usage, a basic purpose of TAU is to manage the routing path in mobile IP based transmission. A second usage is to manage the UE location within the network. The UE reports the change or unchange of a tracking area (TA) to an MME (Mobility Management Entity) using a NAS (Non Access Spectrum) message. The network can recognize which tracking area (TA) includes the UE on the basis of the reported result.

As described above, TAU is performed to confirm the UE location in a mobile communication network. One TA may be composed of a set of several BSs, and one TA is a terminal of a routing path fixed in the IP network. If an IP packet arrives at the UE registered in a specific TA, this packet arrives at a serving gateway associated with an MME managing the corresponding TA. Thereafter, the packet arrives at the base station (BS) through paging.

The network allocates one or more TAs to the UE. The UE in the allocated TA does not perform TAU. The UE confirms a TA received through SIB1 (SystemInformationBlockType1) while in motion, and compares the TA with its own TA list. If the TA change is detected, the UE is registered in the MME through the NAS message so that TAU can be carried out.

In C-RAN, several RRHs interact with one VBS. The VBS divides several RRHs into one or more virtual cells and operates the virtual cells. Compared to the related art in which a tracking area (TA) is composed of several cells, the set of cells is meaningless in the C-RAN. A very large-sized TA may be configured in the C-RAN. In this case, the TA size is excessively increased so that it is difficult to measure UE location and numerous RRH nodes participate in data transmission during paging, resulting in reduction in use efficiency of frequency resources. Due to the above-mentioned reasons, it can be recognized that the most important matter of the idle mode operation under the C-RAN environment is to perform Tracking Area Update (TAU). The present invention proposes a method for performing additional TAU enhancement.

Tracking Area Update (TAU) Enhancement

Assuming that an excessively large-sized region is covered by one VBS in the C-RAN as described above, TAU occurs on the basis of an excessively large-sized unit, and numerous nodes participate in data transmission during paging, such that waste of resources occurs and it is difficult to collect UE location information in an idle mode. There is a need to define a new tracking area (TA) on the basis of an RRH cluster. TAU based on a new TA can operate in the following two cases (1) and (2).

(1) NAS-Based TAU

If the routing region is changed as in the related art, the UE can perform TAU (If VBS/MME is changed, the routing region is changed). For support of IP mobility, signaling can be carried out on the basis of a NAS message.

(2) RAN-Based TAU

FIG. 8 is a flowchart illustrating a method for performing RAN-based TAU according to embodiments of the present invention.

For triggering of a newly proposed TAU, the UE can perform TAU when an RRH cluster (i.e., a new TA composed of some RRH clusters) is changed. In this case, TAU may be achieved on the basis of a MAC control element or sequence for paging. A paging message is transmitted on the basis of an RRH cluster (or a new TA composed of some RRH clusters), such that the amount of transmission resources can be reduced.

Prior to execution of TAU, the UE can transmit a random access preamble (message 1) to the serving RRH (S_RRH) in step S810, and can receive a random access response (message 2) to the random access preamble from the serving RRH (S_RRH) in step S820. In order to discriminate between the NAS-based TAU and the RAN-based TAU, if a BS identifier (ID) or an MME ID is changed, the UE can perform NAS-based TAU. If the TA is changed, the UE can perform RAN-based TAU.

Alternatively, assuming that the TA is changed in the same manner as described above, when the UE performs location update, a TAU indication message is contained in the message 3 and is transferred to the serving RRH (S_RRH) in step S830. The serving RRH (S_RRH) confirms whether the received message is based on NAS or RAN, i.e., the S-RRH confirms whether the MME ID is changed or used for TAU in step S840. That is, the TAU indicator contained in the message 3 may indicate whether UE location update is for NAS-based TAU [indicating the change of a BS or MME ID] or for RAN-based TAU [indicating the change of RRH clusters (or some RRH cluster units)]. In this case, the message 3 may be an RRCconnectionRequest message.

If it is determined that the TAU indication message indicates the NAS-based TAU, the serving RRH (S_RRH) can transmit the message 4 in the same manner as in a general RACH. Thereafter, the UE may request TAU from the core network (for example, MME) in step S850. In this case, the message 4 may be a contention resolution (CR) message.

In contrast, assuming that the TAU indication message indicates the RAN-based TAU, the serving RRH (S_RRH) includes a TAU confirmation message in the message 4, and informs the UE of the resultant message 4 in step S860, so that the UE does not transmit an update request to the core network (for example, MME).

In addition, if the TAU indication message indicates the RAN-based TAU, the following methods can be additionally used.

1. If multi-step measurement is performed, UE measurement is performed at a small-zone (RRH) level and is then switched to a large zone level after a predetermined time. For this purpose, a global CSI-RS configuration list is contained in system information so that the UE measurement range can be confirmed. UE measurement can be performed on the basis of the measurement range of the global CSI-RS configuration list contained in system information.

2. If the RRH clusters are changed before n frames prior to the beginning of each paging occasion (PO), UE location registration is performed.

3. Although the legacy method can be applied to TAU based on a TAU timer without change, if a location based service is performed, the range of the location based service is reduced so that movement orbit tracking can be facilitated.

The RAN-based TAU scheme can be performed more easily than the legacy scheme. If the UE location can be registered only using code transmission/reception of RACH, this UE location registration is more efficient in consideration of a location service and the UE location registration need not be updated in a complicated tracking area (TA). The following methods 1 and 2 can be used.

1. UE Specific RACH/TAU Sequence Transmission

A corresponding sequence (RACH/TAU sequence) is specifically allocated to each UE. If an RRH receives the UE-specific RACH/TAU sequence, this means that the UE is in the vicinity of the RRH. It is possible for the BS to perform paging and location services on the basis of the corresponding RRH.

2. Location Update Signal is Newly Defined and Transmitted.

In this case, the following signal requirements may be used. It is natural for the BS not to receive the newly defined location update signal as necessary. Assuming that this signal increases signal complexity and can be used for LBS, the disadvantages caused by relative complexity can be solved.
Low Power/Low Overhead
Higher Multiplexing
Large Space/Secure signal

3. Transmission of TAU Specific Information in Message 3

Location registration may be performed at a MAC message level but not at a sequence level. In other words, there is a need to add an apparatus for guaranteeing UE location privacy. For this purpose, the UE may include a specific code in the message 3, and may transmit the resultant message 3. When the UE enters the idle mode, the base station (BS) transmitting the corresponding code to the UE must periodically update the corresponding code, and can maintain security using the code and sequence number, etc.

Different tracking areas (TAs) may be allocated to respective UEs. For this operation, UE speed, information indicating that the LBS service is used, and information indicating that the UE is fixed may be used.

1. An applicable TA can be allocated according to UE mobility (for example, UE speed).

2. The RRH list requesting no TAU, instead of a TA, is allocated to the fixed UE. If the UE exists from the corresponding region, the UE can perform the TAU.

Assuming that UEs are classified into the LBS service application UE and other UEs not applied to the LBS service, if the LBS service application UE allocates the RRH specific TAU mode or the RRH cluster specific TAU mode, and if a general UE allocates a conventional large-TA based TAU mode, UEs can be applied in different ways according to service resolution.

Exemplary embodiments described hereinbelow are combinations of elements and features of the present invention. The elements or features may be considered selective unless mentioned otherwise. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. Also, it will be obvious to those skilled in the art that claims that are not explicitly cited in the appended claims may be presented in combination as an exemplary embodiment of the present invention or included as a new claim by subsequent amendment after the application is filed.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all changes which come within the equivalent scope of the invention are within the scope of the invention.

### INDUSTRIAL APPLICABILITY

The method for performing tracking area update (TAU) by a user equipment (UE) in a Cloud Radio Access Network (C-RAN) can be applied to various communication systems for industrial purposes.

1. A method for performing a tracking area update (TAU) by a user equipment (UE) in a Cloud Radio Access Network (C-RAN), the method comprising:
transmitting, a message including a tracking area update (TAU) indicator indicating a tracking area update (TAU), to a serving Remote Radio Head (S-RRH),
wherein the tracking area update (TAU) is performed in units of a Remote Radio Head (RRH) cluster.

2. The method according to claim 1, wherein the TAU indicator indicates whether the TAU is a TAU according to a change of an identifier (ID) of a serving base station or a core network, or is a TAU according to a change of the RRH cluster.

3. The method according to claim 1, wherein the TAU indicator is indicated by a random access sequence specifically allocated to the user equipment (UE) in a process for performing random access to the serving RRH.

4. The method according to claim 1, wherein the TAU indicator is indicated by transmission of a MAC message after completion of the random access to the serving RRH.

5. The method according to claim 2, further comprising:
if the TAU indicator indicates a TAU caused by the changed of an identifier (ID) of the serving base station or the core network, requesting a TAU from the core network.

6. The method according to claim 2, further comprising:
if the TAU indicator indicates a TAU caused by the change of the RRH cluster, receiving a TAU confirmation message from the serving RRH, wherein the UE does not request a TAU from the core network upon receiving the TAU confirmation message.

7. The method according to claim 1, wherein the TAU is performed in units of an RRH cluster and a tracking area (TA) is allocated according to UE mobility.

8. A user equipment (UE) for performing a tracking area update (TAU) in a Cloud Radio Access Network (C-RAN), the UE comprising:
a transmitter; and
a processor,
wherein the processor is configured to control the transmitter transmits a message including a tracking area update (TAU) indicator indicating a tracking area update (TAU) to a serving Remote Radio Head (S-RRH), and wherein the processor is configured to control that the tracking area update (TAU) is performed in units of a Remote Radio Head (RRH) cluster.

9. The user equipment (UE) according to claim 8, wherein the TAU indicator indicates whether the TAU is a TAU according to a change of an identifier (ID) of a serving base station or a core network, or is a TAU according to a change of the RRH cluster.

10. The user equipment (UE) according to claim 8, wherein the TAU is performed in units of an RRH cluster and a tracking area (TA) is allocated according to UE mobility.
